(19) United States
(12) Patent Application Publication
(10) Pub. No.: US 2009/0024725 A1
(43) Pub. Date: Jan. 22, 2009

(54) Method and apparatus to integrate and manage an optical network terminal and a broadband home router

(75) Inventors: Marc R. Bernard, Miramar, FL (US); Douglas A. Atkinson, Ashburn, VA (US); Guy M. Merritt, Purcellville, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 11/879,103

(22) Filed: Jul. 16, 2007

(51) Int. Cl. G06F 15/173

(52) U.S. Cl. 709/223

(57) ABSTRACT

Common techniques for processing software updates have Optical Network Terminal (ONT) and Broadband Home Router (BHR) managers to manage the ONTs and BHRs respectively from separate remote locations in a network. In contrast, a system employing ‘an example’ embodiment of the invention may receive network traffic for an ONT and BHR (“components”) via a single management channel. The system parses signals (e.g., software updates) and processes the management signals with a processor in a first component (e.g., ONT). The system converts a remaining software update to a format compatible with a management channel between the components to forward to the second component (e.g., BHR) for processing. In this way, the system may update multiple components using a single management channel. Thus, software updates or other management procedures can be performed using a single management channel with improved efficiency.

### BACKGROUND OF THE INVENTION

Networks, such as the Internet, use Optical Network Terminals (ONTs) and Broadband Home Routers (BHRs) for transmitting data. In operation, the ONT and BHRs are effective for transmitting data separately over Fault-management, Configuration, Accounting, Performance, and Security (FCAPS) channels. Today's networks employ management nodes that have respective ONT managers and BHR managers to manage the ONTs and BHRs, respectively, from remote locations in the networks.

### SUMMARY OF THE INVENTION

A method or corresponding apparatus in accordance with a first example embodiment of the present invention inspects traffic for management messages, including at least one message expected to apply to a first network device. Next, the method or corresponding apparatus determines whether the at least one message applies to a second network device and manages the second network device based on at least one message.

A method or corresponding apparatus in accordance with a second example embodiment of the present invention processes communications according to a state of a system based on Optical Network Terminal (ONT) and Broadband Home Router (BHR) management data. In an event of a power failure, the method or corresponding apparatus activates a common backup power supply, updates a state of the system based on new ONT and BHR management data, and continues to process communications according to an updated state of the system.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a high level network diagram of a network management system communicating with multiple network components;

FIG. 1B is a high level network diagram of a network in which a management node communicates with a processing node via two separate communications protocols;

FIG. 1C is an example network in which a management node communicates with a processing node via two separate communications protocols;

FIG. 1D is a close-up view of a processing unit in accordance with an embodiment of the present invention;

FIG. 1E is a high level network diagram of a network in which a management node manages two separate protocols;

FIG. 1F is a high level network diagram of a network in which a management node manages at least two separate protocols;

FIG. 2 is a block diagram of an example processing unit in which an embodiment of the present invention is employed;

FIG. 3 is a flow diagram illustrating an example embodiment for managing network devices;

FIG. 4 is a flow diagram to update network devices according to an embodiment of the present invention;

FIG. 5A is a flow diagram illustrating an example network managing OpenManage Client Instrumentation (OMCI) messages of network devices;

FIG. 5B is a flow diagram illustrating an example network managing TR-069 messages of network devices;

FIG. 6 is a diagram of an example message structure used by an embodiment of the present invention;

FIG. 7A is a diagram of example network devices managing network traffic in accordance with an embodiment of the present invention; and

FIG. 7B is a close-up view of an example management unit in accordance with an embodiment of the present invention.

### DETAILED DESCRIPTION OF THE INVENTION

A description of example embodiments of the invention follows.

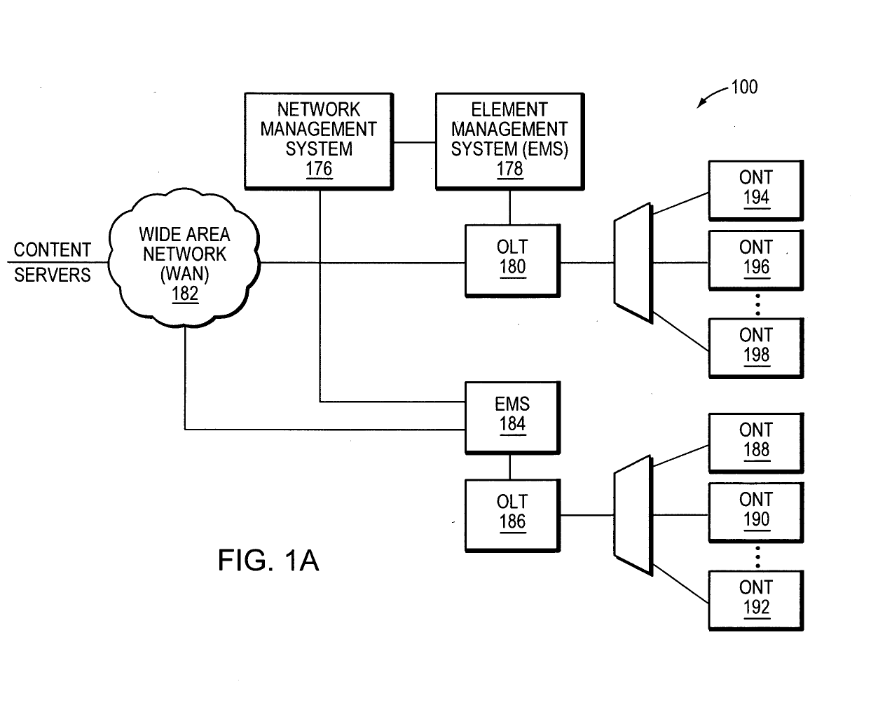

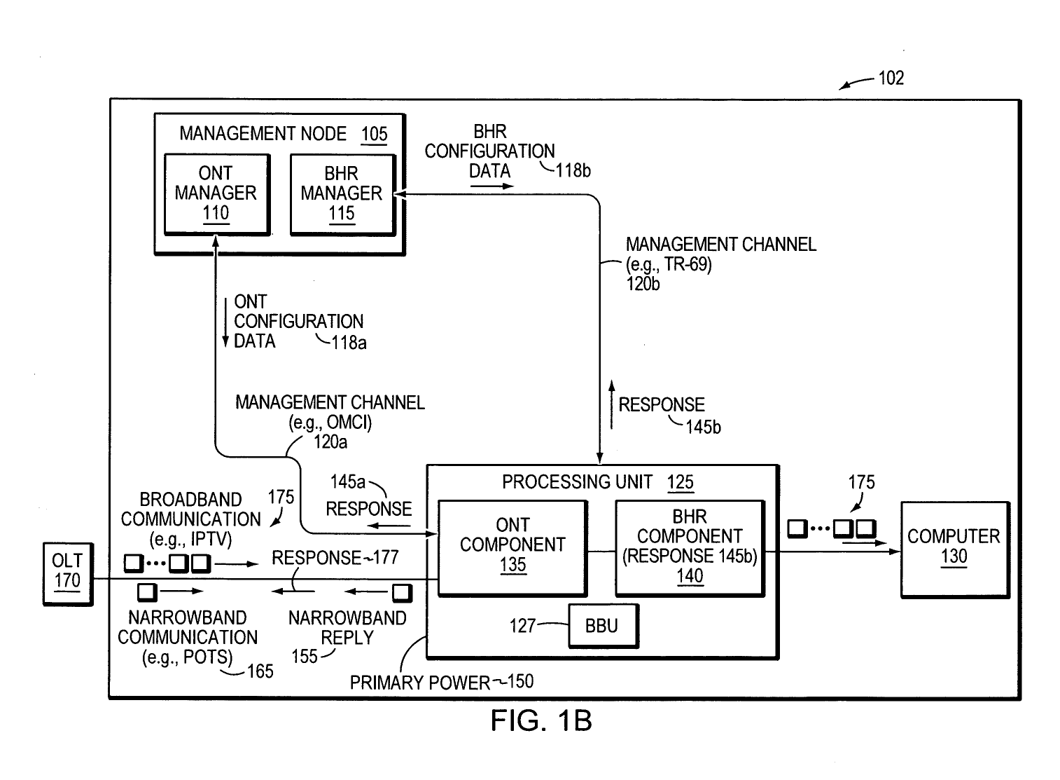

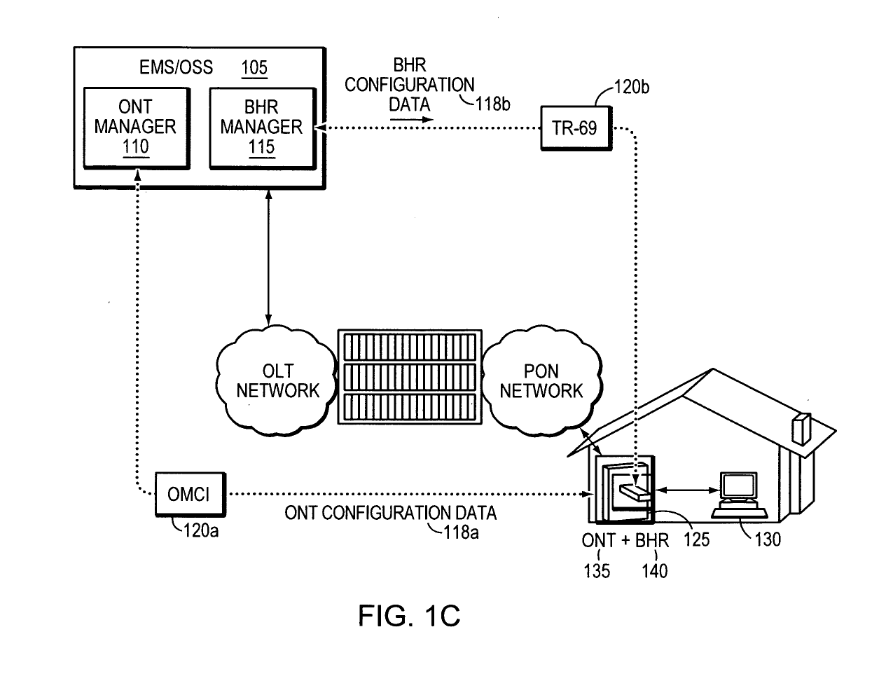

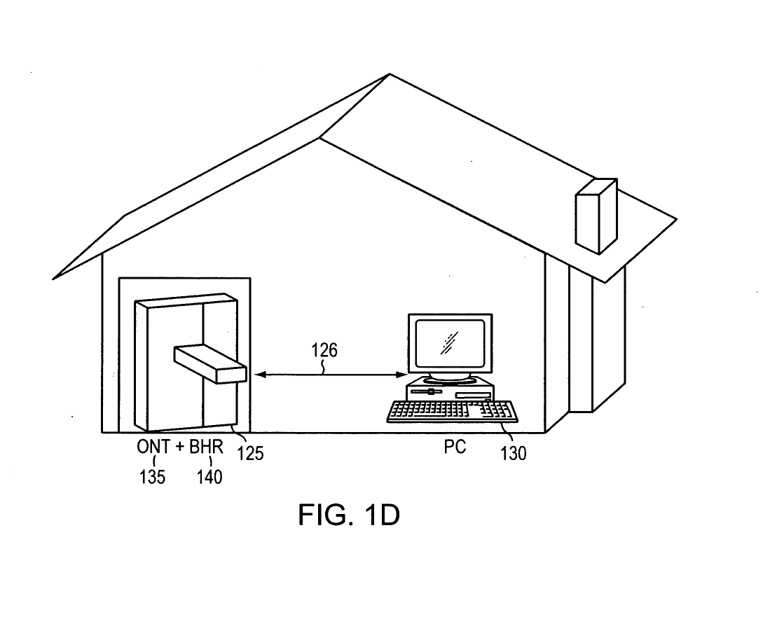

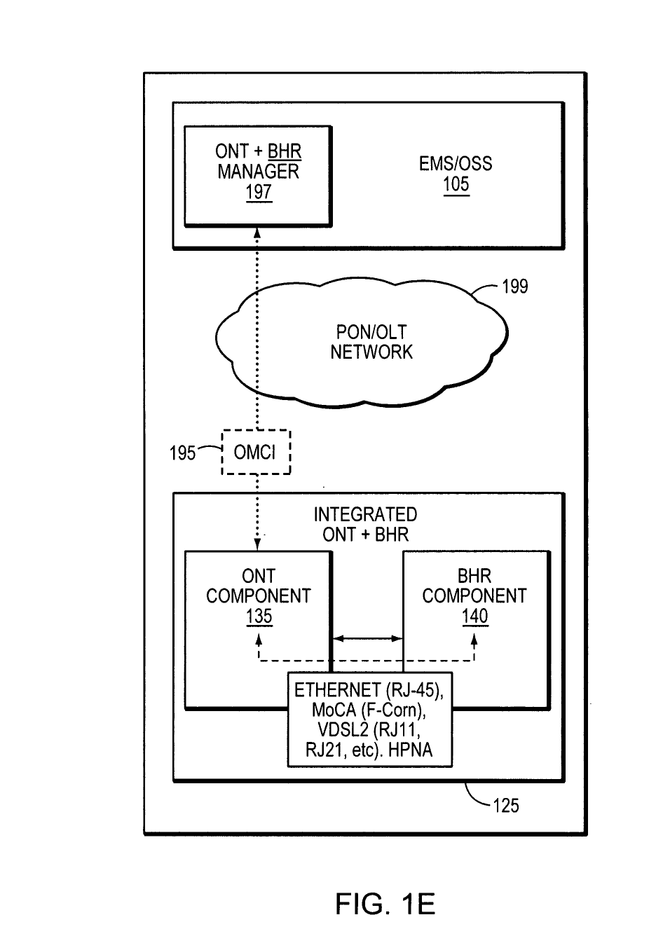

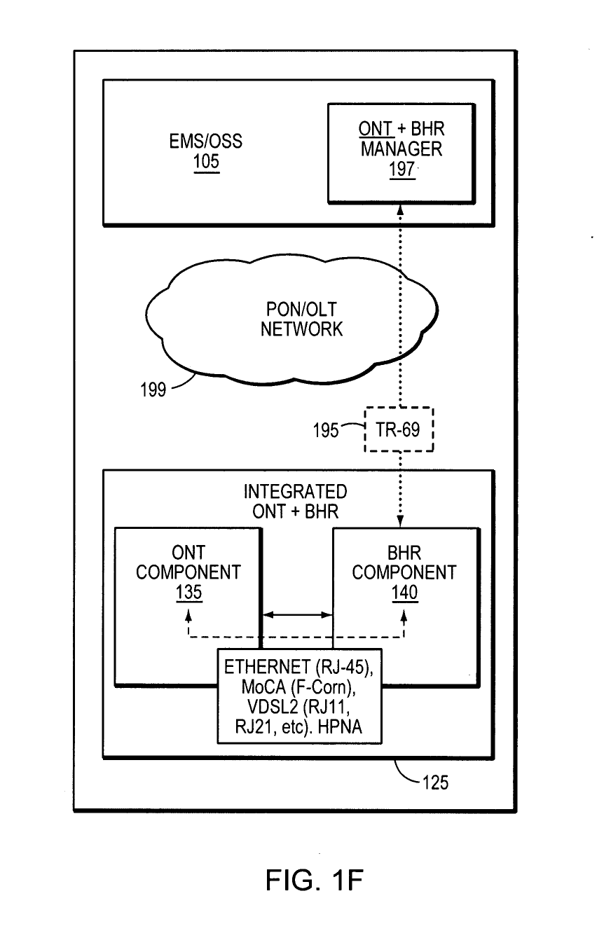

FIG. 1A is a high level network diagram 100 of a network management system communicating with multiple network components. The network diagram 100 includes a network management system 176, multiple Element Management System(s) (EMSs) 178, 186, multiple Optical Line Termination(s) (OLTs) 180, 186, multiple Optical Network Terminal(s) (ONTs) 194, 196, 198, 188, 190, 192, and a Wide Area Network (WAN) 182. In use, the network management system 176 receives configuration data for one or more EMSs 178, 186. Using the configuration data, the network management system 176 updates the EMSs 178, 186 and each corresponding OLT 180, 186 and ONT 194, 196, 198, 188, 190, 192, respectively. After updating, the EMSs, OLTs, and ONTs communicate over the WAN 182 with content servers with updated configuration data.

FIG. 1B is a high level network diagram of a network 102 in which a management node 105 communicates with a processing unit 125 via Fault-management, Configuration, Accounting, Performance, and Security (FCAPS) channels. In an example embodiment, the management node 105 is an Operation Support System (OSS)/Element Management System (EMS) management device. Further, the management node 105 includes one or more managers, such as an Optical Network Terminal (ONT) manager 110 and a Broadband Home Router (BHR) manager 115, for communicating with the processing unit 125. For communicating, the processing unit 125 includes an ONT component 135 and a BHR component 140.

In operation, a manager 110, 115 of the management node 105 transmits data to the processing unit 125 via management channels 120a or 120b, depending on which manager 110, 115 is communicating with its respective managed device. Alternatively, it should be understood that either management channel may be used with either manager or any combination of managers. For example, an ONT manager 110 may use a TR-069 channel, OpenManage Client Instrumentation (OMCI) channel, or other suitable FCAPS channel for ONT management. It should also be understood that the channels 120a, 120b are logical channels and may traverse a common physical path.

In an example embodiment, the ONT manager 110 processes a software image (e.g., a software update) and performs an update at the ONT component 135. More specifically, the ONT manager 110 transmits a software update in the form of BHR configuration data 118b, using an OMCI management channel to the processing unit 125. Responsively, the ONT component 135 processes each software update relating to the ONT and parses the software update for parameters that relate to a BHR component 140. If the ONT component 135 finds BHR component 140 parameters, the ONT component 135 sends the parameters to the BHR component 140, which, in turn, processes the parameters for the software update and converts the response 145b to a format recognized by the sending management channel (e.g., OMCI format). That is, the ONT component 135 causes the BHR component 140 (e.g., a second network device) to activate usage of the subset of the management data (e.g., content). Next, the BHR component 140 returns the response 145b to the processing unit 125, which transmits the response 145b upstream to the management node 105. In this way, the processing unit 125 can process software images/updates for multiple managers having different management channels for communication.

It should be understood that the BHR component 140 may also parse a software update (e.g., the ONT configuration data 118a) and forward the software update to an ONT component 135. The ONT component 135, in turn, may provide a response 145a to the ONT manager 110. It should be further understood that the parsing and converting of messages in the ONT component 135 or BHR component 140 may be performed in an Operation Support System/Element Management System (OSS/EMS), such as an OLT. Moreover, the parsing and converting of messages in the ONT component 135 is not limited to parsing only BHR component 140 messages. Instead, the ONT component 135 may also parse and convert messages for any device connected to the ONT or any device with which the ONT communicates.

After performing software updates, the ONT and BHR component 135, 140 are configured to communicate with an OLT 170. In one embodiment, the OLT 170 sends broadband communications 175, such as IPTV, to the BHR component 140 through the ONT component 135 for transmission to a computer 130. During transmission, the BHR component 140 provides an appropriate response 177 to the broadband communications 175 and may also receive narrowband communications 165 (e.g., POTS) and send a narrowband reply 155. The BHR component 140 transmits and receives the data using a primary power 150. It should be understood that in the event of a failure of primary power 150 in the processing unit 125, the BHR component 140 can use a common Battery Backup Unit (BBU) 127, thereby allowing the BHR component 140 to respond to the broadband communication 175. Should conservation of the battery power of the BBU 127 be useful, the BHR component 140 may process in narrowband (e.g., narrowband communication/reply 155, 165) or other format to conserve battery life.

In example embodiments, the ONT component 135 and BHR component 140 provide many advantages by being integrated in the processing unit 125. Some advantages to a user (e.g., a technician) include providing visible diagnostic Light-Emitting Diodes (LEDs) at each end point of an internal communications path. The visible LEDs allow a technician to quickly identify a problematic connection or failure. Further, some components, such as the BHR component 140, do not use a battery backup unit 127, but the BHR component 140 obtains the benefit of backup because the processing unit 125 shares an integrated power circuit and battery backup unit 127 for each component. Using an integrated power circuit and battery backup unit 127 minimizes downtime and is particularly useful when providing video services and Plain Old Telephone Service (POTS) services. While providing services (e.g., communications), the battery backup unit 127 allows a BHR component 140 to have backup power in the event of a power failure. Thus, the BHR component 140 may continue processing at least a subset of the communications. Another advantage includes additional space for installation as a technician, through combining the two components 135, 140, installs a single processing unit 125 instead of multiple separate components having processing units (e.g., BHR and ONT components 135, 140). Since a single processing unit 125 is used, the BHR component 140 has the added benefit of receiving battery backup from the battery backup unit 127 without occupying additional space. Thus, an unexpected result of combining the BHR and ONT components 135,140 in a processing unit 125 is that it uses less space yet includes more features (e.g., a battery backup unit 127).

FIG. 1C is an example network in which a management node communicates with a processing node via two separate communications protocols. In an example embodiment, an Operation Support System (OSS)/Element Management System (EMS) management device 105 includes one or more managers, such as an Optical Network Terminal (ONT) manager 110 and a Broadband Home Router (BHR) manager 115. Further, a processing unit 125 includes an ONT component 135 and a BHR component 140.

In operation, a manager 110, 115 of the OSS/EMS management device 105 transmits data over an OLT or Passive Optical Network (PON) network to the processing unit 125 via management channels 120a or 120b, depending on which manager 110, 115 is communicating with its respective managed device. For example, the ONT manager 110 transmits a software update in the form of BHR configuration data 118b or ONT configuration data 118a to the processing unit 125. Responsively, the ONT component 135 processes each software update relating to ONTs and parses the software update for parameters that are for a BHR component 140. If the ONT component 135 finds BHR component 140 parameters, the ONT component 135 sends the parameters to the BHR component 140, which, in turn, processes the software update and converts the response 145b to a format recognized by the sending management channel (e.g., OMCI format). That is, the ONT component 135 causes the BHR component 140 (e.g., a second network device) to activate usage of the subset of the management data (e.g., content). After updating, the processing unit 125 may communicate with a computer 130.

FIG. 1D is a close-up view of a processing unit 125 in accordance with an embodiment of the present invention. In an embodiment, the processing unit 125 includes an ONT component 135 and a BHR component 140 for processing data. The processing unit 125 also includes a communications path 126 for transmitting data, such as IPTV data, to a computer 130.

FIG. 1E is a high level network diagram of a network in which a management node manages at least two separate protocols. In an example embodiment, an OSS/EMS management device 105 includes a manager 197 for managing at least ONT and BHR data. It should be understood that the OSS/EMS management device 105 manages at least a first and second device in a manner such that the first or second device's corresponding management systems would manage the devices. That is, the EMS/OSS management device 105 performs the features of multiple management systems resulting in transparent management of protocols.

In use, the OSS/EMS management device 105 transmits data over a PON/OLT network 199 to a processing unit 125 via a management channel 195. Responsively, the processing unit 125 processes the data relating to an ONT component 135 and parses the software update for parameters that are for a BHR component 140. If the ONT component 135 finds BHR component 140 parameters, the ONT component 135 sends the parameters to the BHR component 140, which, in turn, processes the software update and converts the response to a format recognized by the sending management channel (e.g., OMCI format).

FIG. 1F is a high level network diagram of a network in which a management node manages at least two separate protocols. In an example embodiment, an OSS/EMS management device 105 includes a manager 197 for managing at least ONT and BHR data. In operation, the OSS/EMS management device 105 transmits data over a PON/OLT 199 network to a processing unit 125 via a management channel 195. Responsively, the processing unit 125 processes the data relating to an ONT component 140 and parses the software update for parameters that are for a BHR component 135. If the BHR component 140 finds ONT component 135 parameters, the BHR component 140 sends the parameters to the ONT component 135, which, in turn, processes the software update and converts the response to a format recognized by the sending management channel (e.g., TR-069 format).

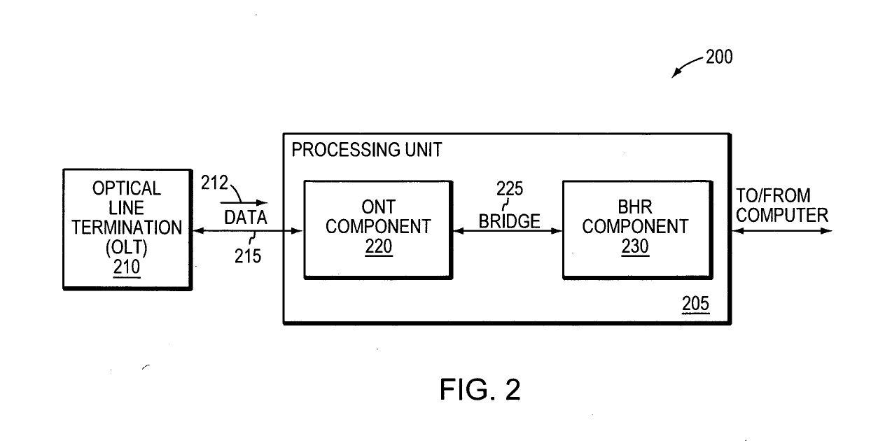

FIG. 2 is a schematic diagram 200 of an example processing unit 205 that includes an ONT component 220, bridge 225, and BHR component 230. In use, an Optical Line Termination (OLT) 210 sends data 212 to the processing unit 205 via a first communications path 215. After receiving the data 212, the ONT component 220 processes any relevant subset of the data 212, including one or more software updates, and forwards the data 212 or remaining data (i.e., data other than the subset), if any, over the bridge 225 for processing by the BHR component 230.

The BHR component 230 performs the software updates and forwards network responses, if applicable, back to the ONT component 220 over the bridge 225. In this way, the processing unit 205 processes multiple software updates over a single management channel. It should be understood that the ONT component 220, BHR component 230, or other component may be used in an interchangeable manner to process software updates. It is useful to note that each component in the processing unit 205 may be in the form of line cards connected to a primary mother board or other suitable variation.

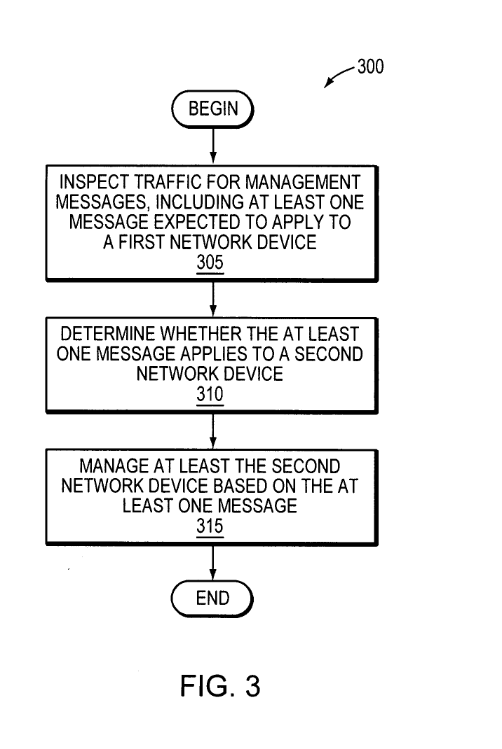

FIG. 3 is a flow diagram 300 illustrating an example process for managing network devices. After beginning, the process inspects (305) traffic for management messages, including at least one message expected to apply to a first network device, such as the ONT component 220 of FIG. 2. Next, the process determines (310) whether the message applies to a second network device, such as the BHR component 230 of FIG. 2. If the message applies to the second device, the process manages (315) at least the second network device based on at least one message. In one embodiment, the process is executed by the ONT component 220, and the ONT component 220 manages the BHR component 230. Alternatively, the process may be executed by the BHR component 230, and the BHR component 230 can manage the ONT component 220.

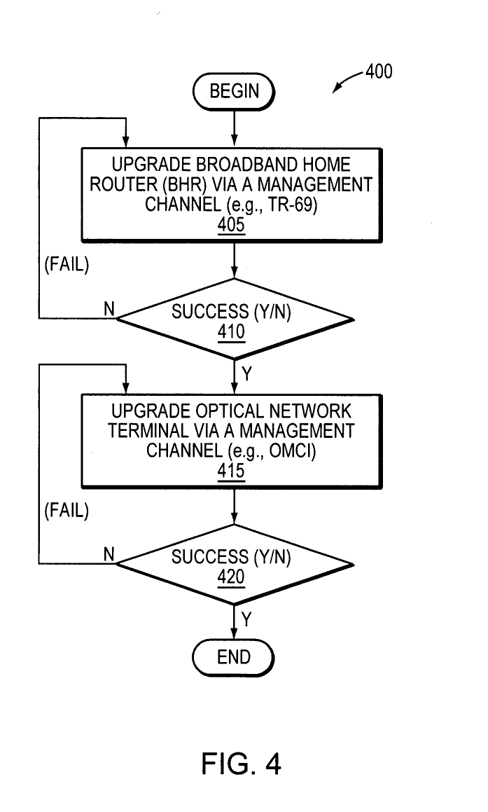

FIG. 4 is a flow diagram 400 that illustrates updating network devices via the flow diagram 300 or FIG. 3. Referring to FIG. 4, upon beginning, a process attempts to upgrade a BHR via a management channel, such as TR-069 (405). A BHR component parses (e.g., inspects) management message(s) for upgrades relating to the BHR component and determines that upgrades exist. The BHR component installs the update and determines the status of the upgrade (e.g., success or failure) (410). If the upgrade fails, the upgrade is repeated until successful. Once the upgrade is successful, the process passes the remaining upgrade information to another network device, such as the ONT component. Next, the process attempts to upgrade the ONT component via a management channel, such as OMCI (415). After attempting the upgrade, the process determines the status of the upgrade (e.g., success or failure) (420) and continues installing the upgrade of the ONT component until successful. Once the ONT component upgrade is successful, the process ends. It should be understood that the BHR component, ONT component, or other component can be used to parse the upgrades. Further, the upgrades may typically be parsed in any order (e.g., ONT component before BHR component and vice versa).

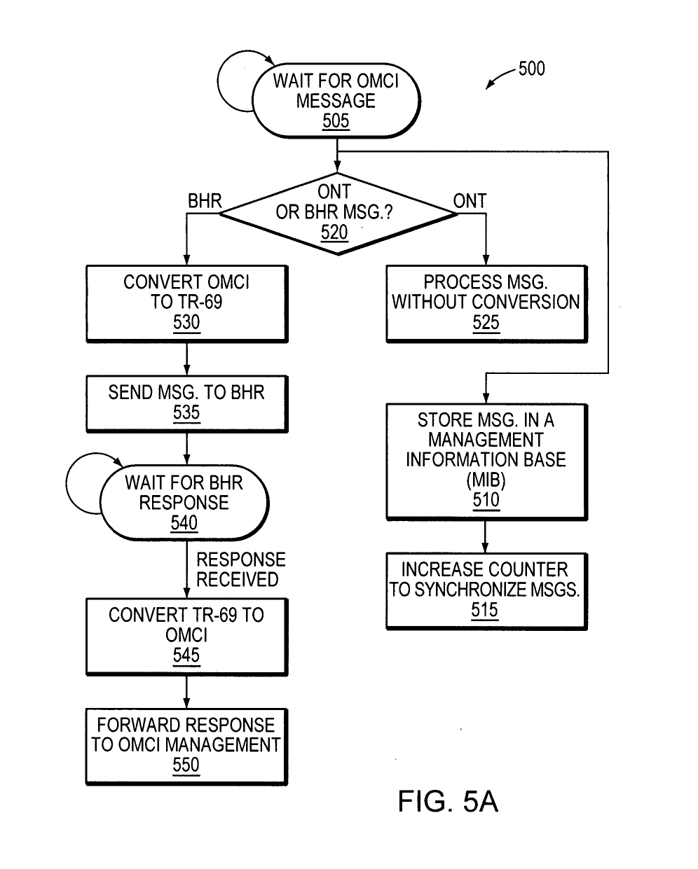

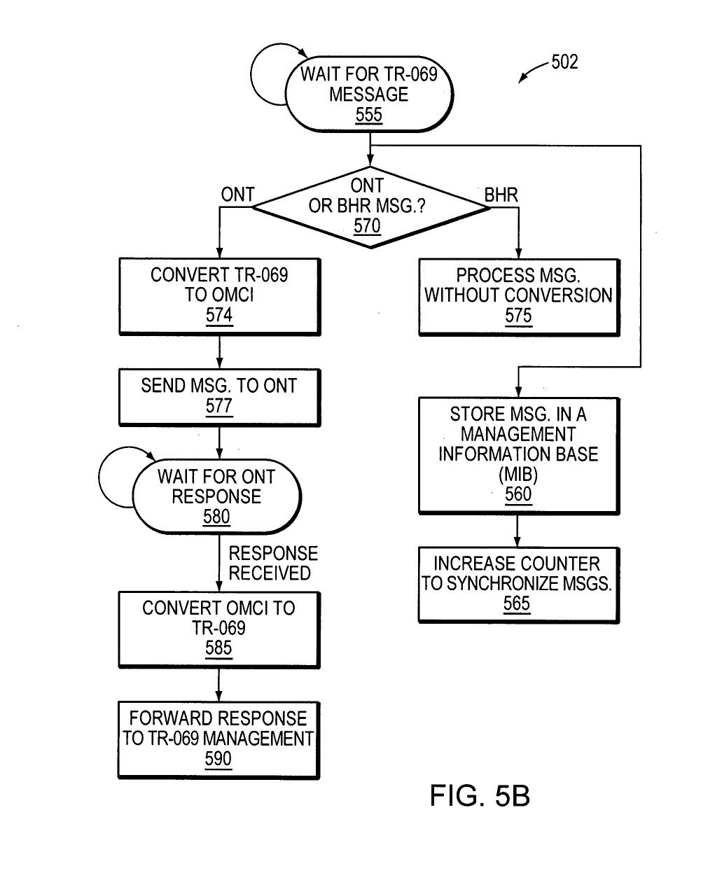

FIG. 5A is a flow diagram illustrating an example of how a network can manage messages of network devices. In the example flow diagram, an OMCI manager (e.g., OLT or EMS) sends an OMCI message to a process 500 waiting for the OMCI message (505). After receiving the OMCI message, the process 500 stores (510) the OMCI message in a central Management Information Base (MIB), increases a counter to synchronize the OMCI messages (515), and stores data in ONT memory (e.g., Random Access Memory (RAM)). With the central MIB and counter information, the process 500 verifies processing of each OMCI message by comparing the counter and central MIB information with other MIBs (e.g., an ONT MIB). That is, the central MIB information and counters are compared to the individual ONT and BHR MIBs to ensure the data is synchronized. It is useful to note that the central MIB information may include configuration information for the ONT component, BHR component, or other components.

In addition to storing the message information in the central MIB, the process 500 determines (520) whether the OMCI message is an ONT message, BHR message, BHR-specific sector, or ONT specific sector. If the OMCI message is an ONT message, the message is processed (525) by an ONT component without conversion because the ONT component is compatible with OMCI. If the OMCI message is a BHR message, the process 500, using the image stored in ONT memory, converts (530) the OMCI message to TR-069 or other compatible management channel format. After converting the message (if applicable), the process 500 sends (535) the message to the BHR component. Next, the process 500 waits (540) for a response, if applicable, from the BHR component. After receiving a response (or determining no response is applicable) from the BHR component, the process 500 converts (545) the response to an OMCI format for compatible transmission with the ONT component. Once the response is converted, the process 500 forwards (550) the response to the OMCI management (e.g., an OLT or OSS/EMS).

FIG. 5B is a process 502 illustrating an example of how a network can manage messages of network devices. For example, a TR-069 manager (e.g., OLT or EMS) sends an TR-069 message to the process 502 waiting for the message (555). After receiving the message, the process 502 stores (560) the TR-069 message in a central Management Information Base (MIB), increases a counter to synchronize the TR-069 messages (565), and stores data in BHR memory (e.g., Random Access Memory (RAM)). With the central MIB and counter information, the process 502 verifies processing of each TR-069 message by comparing the counter and central MIB information with other MIBs (e.g., a BHR MIB). That is, the central MIB information and counters are compared to the individual ONT and BHR MIBs to ensure the data is synchronized. It is useful to note that the central MIB information may include configuration information for the ONT component, BHR component, or other components.

In addition to storing the message information, the process 502 determines (570) whether the TR-069 message is an ONT message, BHR message, BHR-specific sector, or ONT specific sector. If the TR-069 message is a BHR message, the message is processed (575) by a BHR component without conversion because the BHR component is compatible with TR-069. If the TR-069 message is an ONT message, the process 502 uses the image stored in memory and converts (574) the TR-069 message to OMCI or other compatible management channel format. After converting the message (if applicable), the process 502 sends (577) the message to the ONT component. Next, the process 502 waits (580) for a response, if applicable, from the ONT component. After receiving a response (or determining no response is applicable) from the ONT component, the process 502 converts (585) the response to an TR-069 format for compatible transmission with the BHR component. Once the response is converted, the process 502 forwards (590) the response to the TR-069 management (e.g., an OLT or OSS/EMS).

It should be understood that the use of an OMCI and TR-069 messages are for illustrative purposes. Example embodiments may use a variety of managers and perform a variety of conversions to facilitate proper data transmission. That is, the processes 500 or 502 are intended to be independent of a particular message, component or management channel.

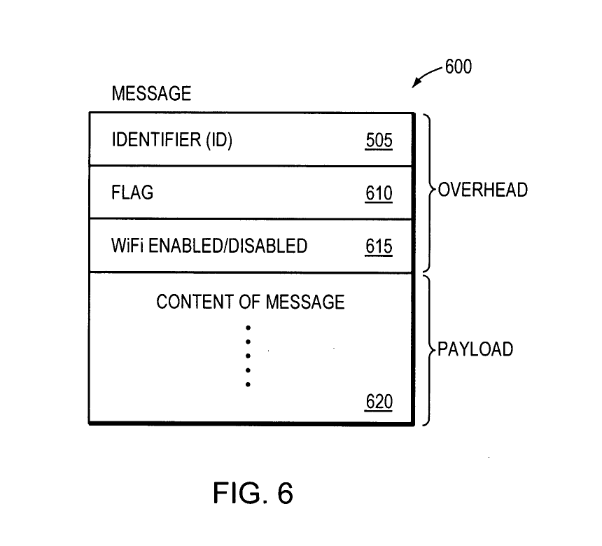

FIG. 6 is an example of a message structure. In particular, FIG. 6 is a diagram 600 that includes a message structure having an identifier (ID) 605, flag 610, WiFi indicator 615, and content of the message 620. The ONT and BHR components parse the message structure for configuration data. The message structure may then be stored in a MIB and used to manage network traffic.

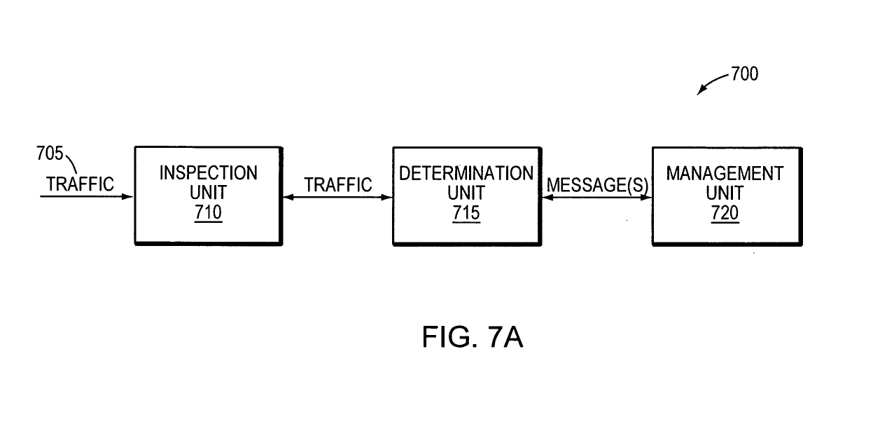

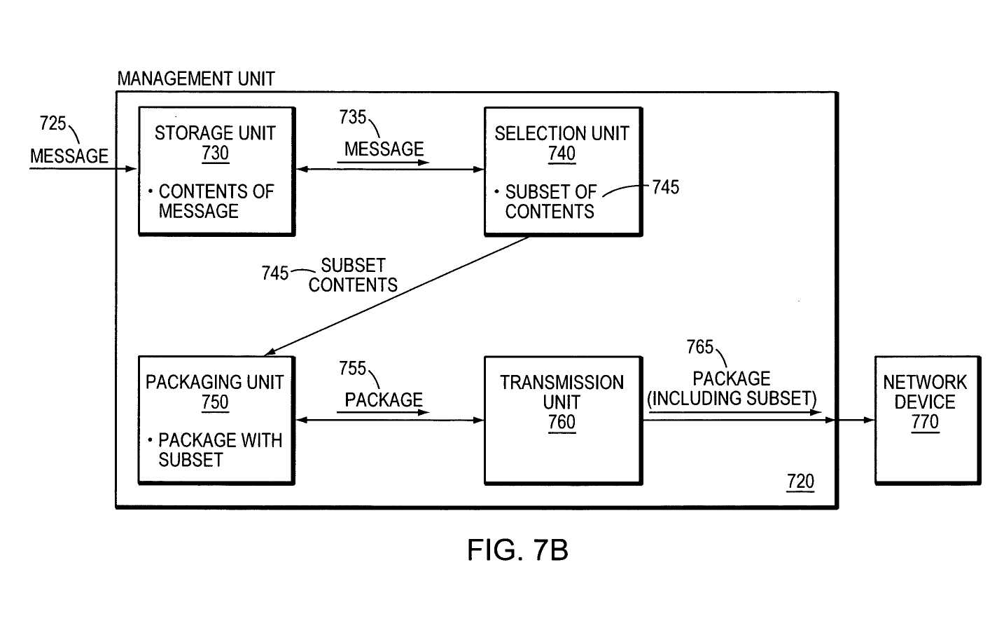

FIG. 7A is a diagram 700 of example network nodes managing network traffic. In an example embodiment, an inspection unit 710 receives network traffic 705, inspects the traffic for management messages (710), and forwards the traffic to a determination unit 715. The determination unit 715 determines whether a message, which is expected to apply to a first network device, applies to a second network device. Next, the determination module 715 forwards each message that applies to the second network device to a management unit 720. The management unit 720 manages the second network device (not shown) based on the message.

FIG. 7B is a close-up view of an example management unit 720 in accordance with an embodiment of the present invention. The management unit 720, includes a storage unit 730, selection unit 740, packaging unit 750, and transmission unit 760 for transmitting data to a network device 770. In operation, the management unit 720 receives a message (e.g., a management message) 725 and stores the contents of the message in the storage unit 730. After storing the contents of the message, the selection unit 740 obtains the message 735, selects a subset of the contents 745, and sends the subset of the contents 745 to the packaging unit 750. In turn, the packaging unit 750 packages the subset of the contents and sends a package 755 to the transmission unit 760. The transmission unit 760 forwards the package 765, including the subset, to a network device 770 for processing. In this way, the management unit 720 process a message 725 (e.g., a software update or management message) for a network device 770.

It should be understood that any of the processes disclosed herein, such as the managing network devices, inspecting traffic, or flow diagrams of FIGS. 3, 4, and 5, may be implemented in the form of hardware, firmware, or software. If implemented in software, the software may be processor instructions in any suitable software language and stored on any form of computer readable medium. The processor instructions are loaded and executed by a processor, such as a general purpose or application specific processor, that, in turn, performs the example embodiments disclosed herein.

While this invention has been particularly shown and described with references to example embodiments thereof, it will be understood by those skilled in the art that various changes in form and details may be made therein without departing from the scope of the invention encompassed by the appended claims.

What is claimed is:

1. A method of managing network devices, comprising:
inspecting traffic for management messages, including at least one message expected to apply to a first network device;
determining whether the at least one message applies to a second network device; and
managing at least the second network device based on the at least one message.

2. The method of claim 1 wherein the first network device is upstream of the second network device.

3. The method of claim 1 wherein the first network device is downstream of the second network device.

4. The method of claim 1 wherein determining whether the management message applies to a second network device further comprises parsing the management message for an identifier specifying whether the management message applies to the first or second network device.

5. The method of claim 1 wherein determining whether the management message applies to a second network device further comprises identifying the management message is for the first or second network device based on an indicator in or relating to the management message.

6. The method of claim 1 further comprising transmitting the management message over a second bus.

7. The method of claim 6 wherein managing at least the second network device further comprises repackaging the management message to transmit to the second network device via the second bus.

8. The method of claim 1 wherein managing at least the second network device further comprises responding to the management message by the first network device.

9. The method of claim 1 wherein managing at least the second network device further comprises:
storing contents of the management message;
selecting a subset of the contents stored;
packaging the subset of the contents; and
forwarding the subset of the contents to the second network device.

10. The method of claim 9 further comprises causing the second network device to activate usage of the subset of the contents.

11. The method of claim 1 further comprising maintaining message synchronization between at least one of the following: the first network device, the second network device, or a third network device.

12. The method of claim 1 further comprising acting, by the first network device, upon receiving notifications from the second network device.

13. The method of claim 1 wherein the first network device is an Optical Network Terminal (ONT) and the second network device is a Broadband Home Router (BHR).

14. The method of claim 1 wherein the first network device is a Broadband Home Router (BHR) and the second network device is an Optical Network Terminal (ONT).

15. An apparatus for managing network devices, comprising:
an inspection unit to inspect traffic for management messages, including at least one message expected to apply to a first network device;
a determination unit to determine whether the at least one message applies to a second network device; and
a management unit to manage at least the second network device based on the at least one message.

16. The apparatus of claim 15 wherein the first network device is upstream of the second network device.

17. The apparatus of claim 15 wherein the first network device is downstream of the second network device.

18. The apparatus of claim 15 wherein determination unit further comprises a parsing unit to parse the management message for an identifier specifying whether the management message are to manage the first or second network device.

19. The apparatus of claim 15 wherein the determination unit further comprises a determination unit to determine the management message is for the first or second network device based on the contents of the management message.

20. The apparatus of claim 15 further comprising a transmission unit to transmit the management message over a second bus.

21. The apparatus of claim 20 wherein the management unit further comprises a packaging unit to repackage the management message to transmit to the second network device via the second bus.

22. The apparatus of claim 15 wherein the management unit further comprises a response unit responding to the management message by the first network device.

23. The apparatus of claim 15 wherein the management unit further comprises:
a storage unit to store contents of the management message;
a selection unit to select a subset of the contents stored;
a packaging unit to package the subset of the contents; and
a transmission unit to forward the subset of the contents to the second network device.

24. The apparatus of claim 23 further comprising an activation unit to cause the second network device to activate usage of the subset of the contents.

25. The apparatus of claim 15 further comprises a synchronization unit to maintain message synchronization between at least two of the following devices: the first network device, second network device, and a third network device.

26. The apparatus of claim 15 further comprising a processing unit to act, using a first network device, upon notifications from the second network device.

27. The apparatus of claim 15 wherein the first network device is an Optical Network Terminal (ONT) and the second network device is a Broadband Home Router (BHR).

28. The apparatus of claim 15 wherein the first network device is a Broadband Home Router (BHR) and the second network device is an Optical Network Terminal (ONT).

29. A method of managing network devices, comprising:
processing communications according to a state of a system based on Optical Network Terminal (ONT) and Broadband Home Router (BHR) management data;
activating a common backup power supply in an event of a power failure; and
updating a state of the system based on new ONT and BHR management data; and
continuing to process communications according to an updated state of the system.

30. A method of managing network devices, comprising:
a management unit with processors to process communications according to ONT and BHR management data; and
a battery backup unit common to the processors to provide backup power, in the event of a power failure, to the processors to continue processing at least a subset of the communications.
